(19) United States
(12) Patent Application Publication
(10) Pub. No.: US 2005/0286174 A1
(43) Pub. Date: Dec. 29, 2005

(54) Head drum assembly and magnetic recording/reproducing apparatus having the same and a method for assembling a head drum assembly

(75) Inventors: Chung-Hum Baik, Suwon-si (KR); Myoung-Joon Kim, Suwon-si (KR); Bong-Joo Kim, Suwon-si (KR); Jae-Kab Seo, Suwon-si (KR); Jun-Young Kim, Suwon-si (KR); Young-Ho Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/066,381

(22) Filed: Feb. 28, 2005

(30) Foreign Application Priority Data
Jun. 28, 2004 (KR) 2004-48818

(51) Int. Cl. G11B 5/52

(52) U.S. Cl. 360/271.2

(57) ABSTRACT

A head drum assembly and method of a magnetic recording/reproducing apparatus are disclosed. In the assembly, for application of a pre-load on the upper and the lower bearings, the upper and the lower bearings are installed in a loosely fitting manner on the shaft. An elastic member for applying a load on an inner ring of either of the upper and the lower bearings is provided so that simplification of the manufacturing process of the head drum assembly, cost reduction, and productivity improvement are achieved.

### CROSS-REFERENCE TO RELATED APPLICATIONS

This application claims the benefit under 35 U.S.C. § 119(a) from Korean Patent Application No. 2004-48818, filed on Jun. 28, 2004, the entire contents of which are incorporated herein by reference.

### BACKGROUND OF THE INVENTION

1. Field of the Invention

The present invention relates to a magnetic recording/reproducing apparatus. More particularly, the present invention relates to a head drum assembly rotatably mounted on a main deck, for recording and reproducing information on and from a tape and a magnetic recording/reproducing apparatus having the same, and a method for assembling the head drum assembly.

2. Description of the Related Art

Generally, a bearing is installed between a rotary body and a shaft to support the rotary body so that the rotary body may rotate around the shaft. However, due to the tolerance of the bearing, the accuracy of the rotation of the rotary body deteriorates. Thus, a head drum assembly of the magnetic recording/reproducing apparatus requiring high speed and accuracy in rotation compensates for inaccuracies in rotation due to the tolerance of a bearing by applying a predetermined pre-load on the bearing.

FIG. 1 is a cross-sectional view schematically showing a conventional head drum assembly.

Referring to FIG. 1, the head drum assembly of the magnetic recording/reproducing apparatus includes a rotational drum 40 for supporting a magnetic head 44 for recording and reproducing information by scanning a moving magnetic tape; a fixing drum 48 forcedly fit, in parallel with the rotational drum 40, into the lower side of a shaft 10 joined to a middle axial cavity 42 formed in the rotational drum 40; an upper bearing 20 and a lower bearing 30 structured and arranged such that they are located one above the other between the rotational drum 40 and the shaft 10; and a coil spring 50 interposed between the upper bearing 20 and the lower bearing 30 applying a pre-load on the upper bearing 20 and the lower bearing 30 and installed on an outer periphery of the shaft 10, for applying a load on a respective inner ring 22 and 32 in opposite direction.

Here, an outer ring 24 of the upper bearing 20 is forcedly fit in the middle axial cavity 42, and the inner ring 22 of the upper bearing 20 is forcedly fit in the shaft 10. An outer ring 34 of the lower bearing 30 is forcedly fit in the middle axial cavity 42, and the inner ring 32 of the lower bearing 30 is inserted into the shaft 10 in a loosely fitting manner. The coil spring 50 applies a load, in opposing directions, on the inner ring 22 of the upper bearing 20 and the inner ring 32 of the lower bearing 30. Since the inner ring 22 of the upper bearing 20 is forcedly fit in the shaft 10, force applied on the inner ring 22 of the upper bearing 20 by the coil spring 50 is transferred to the shaft and expended. However, since the inner ring 32 of the lower bearing 30 is loosely fit in the shaft 10, force transferred to the inner ring 32 of the lower bearing 30 by the coil spring 50 causes displacement of the inner ring 32 of the lower bearing 30 to the lower part of the rotational drum 40. Accordingly, the force transferred to the inner ring 32 of the lower bearing 30, as shown in FIG. 1, acts on a lower bearing ball 36 to apply a pre-load thereon. Also, the force transferred to the lower bearing ball 36 acts on a lower part of the rotational drum 40 by way of the inner ring 32 of the lower bearing 30 and such force is transferred to the outer ring 24 of the upper bearing 20 forcedly fit in the middle axial cavity 42 of the rotational drum 40 to cause displacement of the outer ring 24 of the upper bearing 20 to a lower position. By such displacement, the force transferred to the outer ring 24 of the upper bearing 20 acts on an upper bearing ball 26 in a direction shown in FIG. 1 to apply a pre-load thereon.

If the upper and the lower bearings 20 and 30 are all forcedly fit in the shaft 10, force of the coil spring 50 is transferred to the shaft 10 and expended. Therefore, a pre-load is not applied on the upper and the lower bearing balls 26 and 36. Also, if both the upper and the lower bearings 20 and 30 are fit in the shaft 10 in a loosely fitting manner, the inner ring 22 and 32 of the upper and the lower bearings 20 and 30 make a relative motion with respect to each other and a problem that the rotational drum 40 moves up and down, is generated. For such a reason, the inner ring 22 of the upper bearing 20 is forcedly fit in the shaft 10 and the inner ring 32 of the lower bearing 30 should be loosely fit in the shaft 10.

However, to form such a pre-load structure in view of the dimensional problem of the inner ring where the inner ring 22 of the upper bearing 20 should be forcedly fit in the shaft 10 and the inner ring 32 of the lower bearing 30 should be loosely fit in the shaft 10, an inner diameter of the inner ring 22 of the upper bearing 20 is not the same as an inner diameter of the inner ring 32 of the lower bearing 30 and two types of bearings should be used. Since two types of bearings should be used, the assembly process becomes complicated, and the manufacturing costs of the bearings also increases.

An assembly order of the head drum assembly will be briefly described. The upper bearing 20 is forcedly fit in the shaft 10. Next, the upper bearing 20 forcedly fit in the shaft 10 is forcedly fit in the rotational drum 40. Subsequently, the coil spring 50 fits over the shaft 10 from its lower part to its upper part so that the coil spring 50 is positioned on the inner ring 22 of the upper bearing 20. Next, the lower bearing 30 is fit in the shaft 10 and forcedly fit in the rotational drum 40. Lastly, the shaft 10 inserted into the rotational drum 40 is forcedly fit in a drum cover 46 and the fixing drum 48. Since the foregoing process includes lots of forcedly fitting steps, manufacturing efficiency of the head drum assembly is reduced.

### SUMMARY OF THE INVENTION

The present invention has been developed in order to solve the above drawbacks and other problems associated with the conventional art. Therefore, an aspect of the present invention is to provide a head drum assembly capable of improving a pre-load structure, and a magnetic recording/reproducing apparatus having the same.

Another aspect of the present invention is to provide an improved method for assembling a head drum assembly, capable of simplifying an assembly process.

To achieve the above aspects, there is provided a head drum assembly of a magnetic recording/reproducing apparatus, which includes a rotational drum rotatably disposed on a shaft; an upper bearing and a lower bearing installed between the rotational drum and the shaft; and a fixing drum and a drum cover, respectively fixed in the shaft, the head drum assembly of the magnetic recording/reproducing apparatus is configured in such a way, in which to apply a pre-load on the upper and the lower bearings, the upper and the lower bearings are installed, in a loosely fitting manner, in the shaft, and an elastic member for applying a load on an inner ring of either of the upper and the lower bearings is provided.

The upper bearing may have the same inner diameter as the lower bearing.

A projection may be formed on the fixing drum, for supporting the inner ring of the lower bearing, and the elastic member applies a load on the inner ring of the upper bearing.

The elastic member may be a coil spring.

In another aspect of the present invention, there is provided a magnetic recording/reproducing apparatus, which includes a deck on which a variety of parts for recording and reproducing data on and from the magnetic tape is installed; and a head drum assembly having: a rotational drum mounted on the deck and rotatably disposed on a shaft, for recording and reproducing information on and from the magnetic tape; an upper bearing and a lower bearing installed between the rotational drum and the shaft; and a fixing drum and a drum cover fixed in the shaft; wherein for application of a pre-load on the upper and the lower bearings, the upper and the lower bearings are installed, in a loosely fitting manner, on the shaft, and an elastic member for applying a load on an inner ring of either of the upper and the lower bearings is provided.

The upper bearing may have the same inner diameter as the lower bearing.

On the fixing drum, a projection may be formed for supporting the inner ring of the lower bearing, and the elastic member applies a load on the inner ring of the upper bearing.

To achieve the above aspects of the present invention, there is provided a method for assembling a head drum assembly of a magnetic recording/reproducing apparatus rotatably installed on a deck, for recording and reproducing data on and from a magnetic tape. The method includes the steps of making a first assembly by forcedly fitting a shaft in a fixing drum; making a second assembly by forcedly fitting a plurality of bearings in a rotational drum; and combining the first assembly and the second assembly by loosely fitting a plurality of bearings in the shaft; and installing an elastic member on the shaft so that a load is applied on an inner ring of either of a plurality of bearings.

The step of installing the elastic member may include the steps of mounting the elastic member on the shaft so that one side of the inner ring of either of a plurality of bearings is touched by one side of the elastic member; and forcedly fitting the drum cover in the shaft so that a load is applied on the other side of the elastic member.

Also, a plurality of bearings includes an upper bearing and a lower bearing, the fixing drum has a projection in its upper part, and, preferably, the step of combining the first assembly and the second assembly includes the steps of loosely fitting the shaft in the lower bearing; loosely fitting the shaft in the upper bearing; and closely fitting the second assembly in the shaft so that the inner ring of the lower bearing is supported by the projection.

### BRIEF DESCRIPTION OF THE DRAWING FIGURES

The above aspects and features of the present invention will be more apparent by describing certain embodiments of the present invention with reference to the accompanying drawing figures, in which:

FIG. 1 is a cross-sectional view of a conventional head drum assembly;

FIG. 2 is a perspective view schematically showing a magnetic recording/reproducing apparatus according to an embodiment of the present invention;

FIG. 3 is a cross-sectional view taken along line III-III of FIG. 2;

FIG. 4 is a conceptual view illustrating a pre-load principle of upper and lower bearings shown in FIG. 3; and

FIGS. 5A through 5E are cross-sectional views illustrating a process for assembling a head drum assembly according to an embodiment of the present invention.

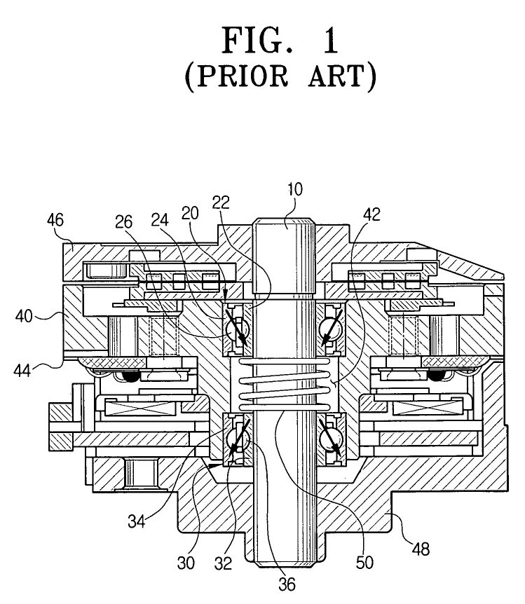

In the drawing figures, it should be understood that like reference numerals refer to like structure and features.

### DETAILED DESCRIPTION OF THE PREFERRED EMBODIMENTS

Construction and operation of embodiments of the present invention will be described in greater detail with reference to the accompanying drawings.

In the following description, the same reference numerals are used for the same elements throughout the drawings. The matters defined in the description such as a detailed construction and elements are exemplary. Thus, it should be apparent that the present invention can be performed without the examples. Also, well-known functions or constructions are not described in detail since they would obscure the invention in unnecessary detail.

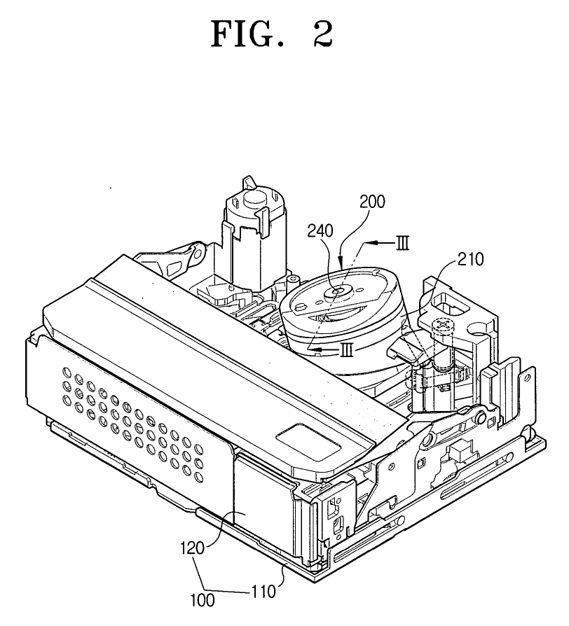

FIG. 2 is a perspective view schematically illustrating a magnetic recording/reproducing apparatus according to an embodiment of the present invention.

Referring to FIG. 2, the magnetic recording/reproducing apparatus according to an embodiment of the present invention includes a deck 100 on which a magnetic tape is mounted and where a variety of parts for recording and reproducing data on and from the magnetic tape is installed, and having a sub-deck 120 and a main deck 110; and a head drum assembly 200 installed on the deck 100, for recoding and reproducing information on and from the magnetic tape. The head drum assembly 200 is installed at a predetermined inclination on the main deck 110 and has a rotational drum 210 rotating at a high speed, for recording and reproducing information on and from the magnetic tape. Such a rotational drum 210 applies a predetermined pre-load, due to its high rotational speed, on a bearing where the rotational drum 210 is rotatably supported by a shaft 240. Such a pre-load structure and the head drum assembly 200 will be described in detail in the following.

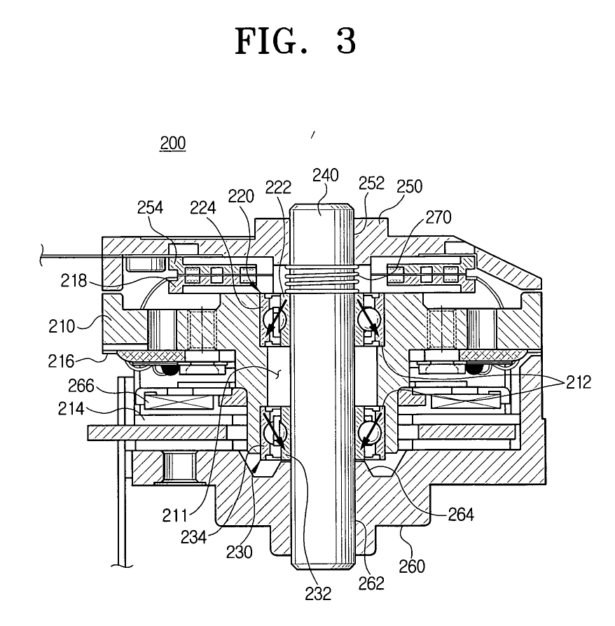

FIG. 3 is a cross-sectional view showing the head drum assembly 200 according to the embodiment of the present invention.

Referring to FIG. 3, the head drum assembly 200 according to the embodiment of the present invention includes a rotational drum 210 whose central axis is arranged in parallel with a shaft 240; upper and lower bearings 220 and 230 arranged up and down between the rotational drum 210 and the shaft 240; a drum cover 250 and a fixing drum 260 arranged up and down of the rotational drum 210 and fixed to both ends of the shaft 240, respectively; and an elastic member 270 installed in such a way that its one end is touched, in a pressing manner, by an inner ring 222 of the upper bearing 220 and its other end is supported by the drum cover 250.

The rotational drum 210 is joined to the shaft 240 with the rotational drum 210 being interposed between the upper and the lower bearings 220 and 230, so that it can rotate around the shaft 240. Such rotation is performed by interaction between a motor stator 214 installed on the fixing drum 260 and the rotor 266 installed in the lower part of the rotational drum 210. If the rotational drum 210 rotates, a head 216 fixed on the rotational drum 210 obtains and records information or, records information onto the magnetic tape.

The outer rings 224 and 234 of the upper and the lower bearings 220 and 230 are forcedly fit on a middle axial cavity 211 formed in the rotational drum 210, so that those bearings 220 and 230 are joined to the rotational drum 210. Also, the upper and the lower bearings 220 and 230 are inserted into the shaft 240 in a loosely fitting manner. The upper end of the inner ring 222 of the upper bearing 220 is touched, in a pressing manner, by the elastic member 270 and the lower end of the outer ring 224 of the upper bearing 220 is settled on a bearing settling part 212 formed on the middle axial cavity 211 of the rotational drum 210. The lower end of the inner ring 232 of the lower bearing is supported by a projection 264 formed on the upper end of a lower axial cavity 262 of the fixing drum 260. Also, the upper end of the outer ring 234 of the lower bearing 230 is settled on a bearing settling part 212 formed on the middle axial cavity 211 of the rotational drum 210.

An upper axial cavity 252 is formed on the drum cover 250 so that the upper part of the shaft 240 is fixed in a forcedly fitting manner. The elastic member 270 is supported by the periphery of the lower part of the upper axial cavity 252. Also, a fixing transformer 254 is installed on the drum cover 250 so that it corresponds to a rotational transformer 218 installed on the rotational drum 210. With such a construction, a signal exchange is possible between the rotational drum 210 and the controlling part. Since a detailed description thereof is obvious to those skilled in the art, a detailed description will be omitted.

A lower axial cavity 262 is formed on the fixing drum 260 so that the fixing drum 260 is fixed to the lower part of the shaft 240 in a forcedly fitting manner. A projection 264 is formed upward on the periphery of the upper end of the lower axial cavity 262, and a lower end of the inner ring 232 of the lower bearing 230 is supported by such a projection 264. Also, a motor stator 214 is installed on the fixing drum 260 so that it corresponds to a rotor 266 fixed on the rotational drum 210.

The elastic member 270 is supported on its one end by the upper end of the inner ring 222 of the upper bearing 220 so that it applies a load on the inner ring 222 of the upper bearing 220. The other end of the elastic member 270 is supported by the periphery of the lower part of the upper axial cavity 252 of the drum cover 250.

Though the fixing transformer 254 is formed on the drum cover 250 and the motor stator 214 is installed on the fixing drum 260 according to the embodiment of the present invention, the present invention is not limited to this construction. Namely, the head drum assembly 200 may change in its construction in such a way that the motor stator 214 is installed in the drum cover 250 and the fixing transformer 254 is installed on the fixing drum 260. Also, a coil spring is shown in the drawing as an example for the elastic member 270, the elastic member is not limited to this and the embodiment of the present invention is applicable to any member as far as it has elasticity.

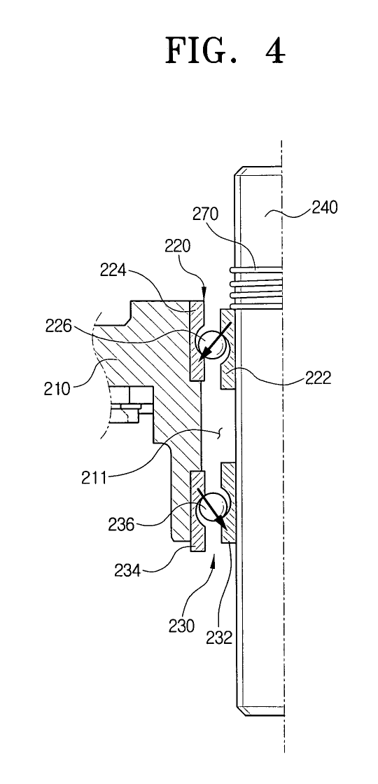

A pre-load is applied, in the direction of an arrow, on the upper and the lower bearings 220 and 230 as shown in FIG. 3. The principle by which such a pre-load is applied, will be described in detail with reference to FIG. 4.

FIG. 4 is a conceptual view explaining the principle by which a pre-load is applied according to the embodiment of the present invention.

Referring to FIG. 4, the elastic member 270 applies a load on the inner ring 222 of the upper bearing 220. By such a load, the inner ring 222 of the upper bearing 220 joined to the shaft 240 in a loosely fitting manner, is moved downward in its displacement. Though the movement in the displacement of the inner ring 222 of the upper bearing 220 is shown in an exaggerated manner for an understanding of this embodiment of the present invention, in reality a fine movement in the displacement that may not be identified by the human eye, is made. As the inner ring 222 of the upper bearing 220 is moved downward in its displacement in this manner, an upper bearing ball is moved downward. However, the outer ring 224 of the upper bearing 220 is forcedly fit in the rotational drum 210, the displacement of the outer ring 224 is not generated. Resultantly, the structure of the upper bearing 220 enters a state as shown in FIG. 4. With such a structure, force applied on the inner ring 222 of the upper bearing 220 by the elastic member 270, is transferred to the upper bearing ball 226 in an arrow direction as shown in FIG. 4 so that a pre-load is applied.

The force applied on the upper bearing ball 226 is transferred to the outer ring 224 of the upper bearing 220. At this point, since the outer ring 224 of the upper bearing 220 is forcedly fit in the rotational drum 210, downward force is applied on the rotational drum 210. The force transferred to the rotational drum 210 is transferred to the outer ring 234 of the lower bearing 230 forcedly fit in the middle axial cavity 211 of the rotational drum 210. By the force transferred in this manner, the outer ring 234 of the lower bearing 230 is moved downward in its displacement. Due to such a displacement, the lower bearing ball 236 is moved slightly downward in its displacement. Due to such a displacement, the lower bearing 230 has an arrangement as shown in FIG. 4. Due to such an arrangement, the force transferred to the outer ring 234 of the lower bearing 230 applies a pre-load, in the direction of the arrow as shown in FIG. 4, on the lower bearing ball 236. According to the above pre-load structure, an inner diameter of the inner ring 222 of the upper bearing 220 and an inner diameter of the inner ring 232 of the lower bearing 230 can be manufactured in the same size, and accordingly, the upper bearing 220 and the lower bearing 230 can be constructed with the same bearing. Therefore, the upper and the lower bearings 220 and 230 need not be assembled separately, so that not only the assembly process is simplified but also costs consumed for production of the bearing can be reduced, because the same bearing is used.

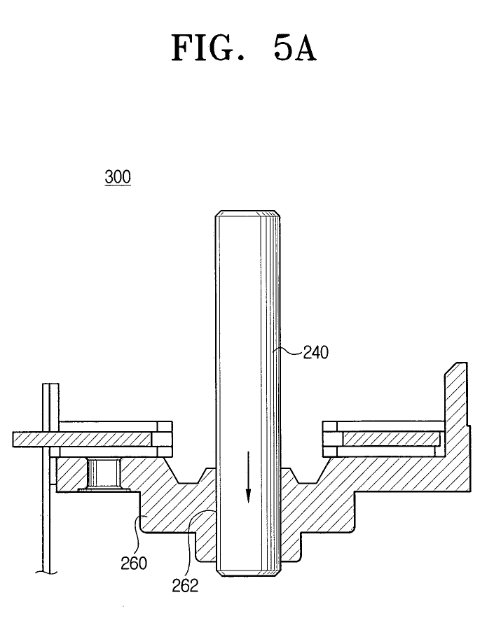

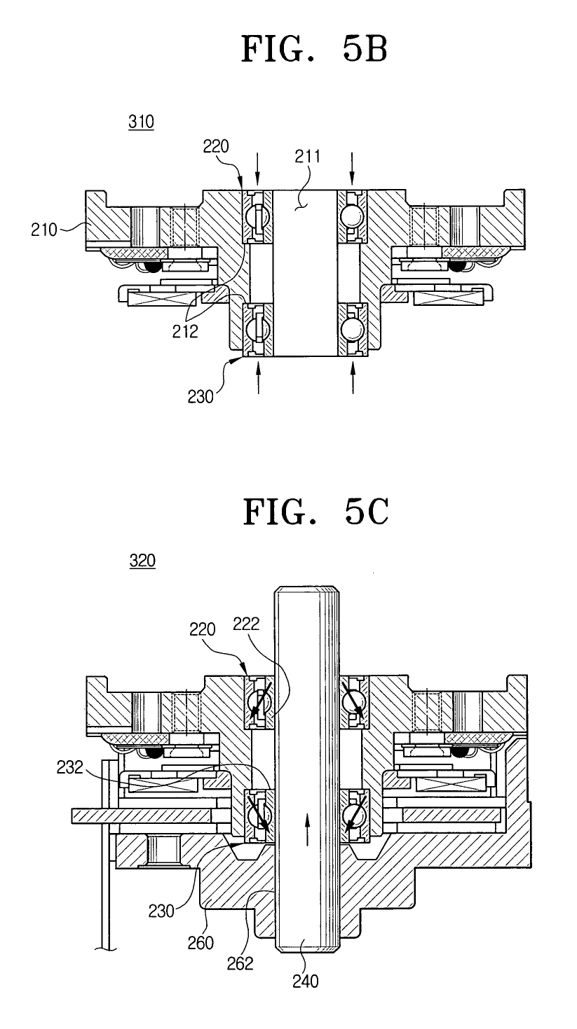

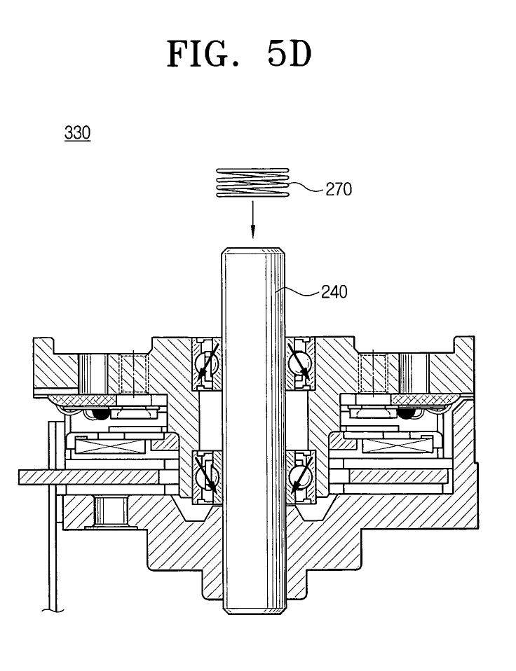

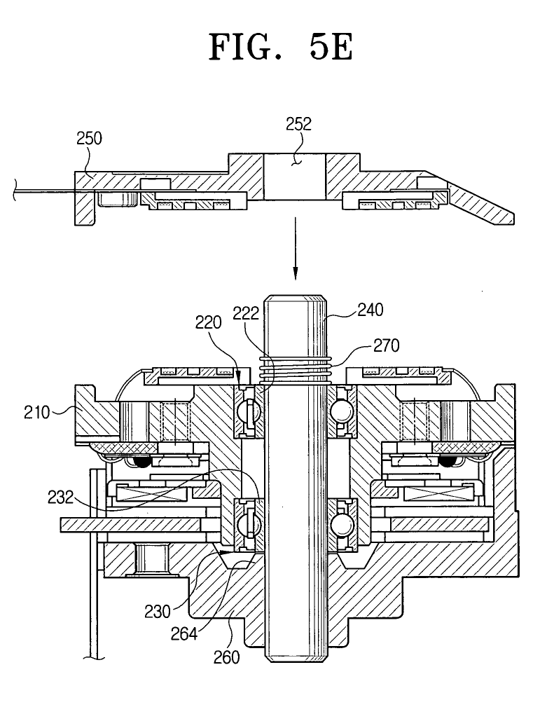

FIGS. 5A through 5E are cross-sectional views illustrating a method for assembling the head drum assembly 200 according to the embodiment of the present invention.

Referring to FIG. 5A, the shaft 240 is forcedly fit in the lower axial cavity 262 formed on the fixing drum 260. By such forcedly fitting, the shaft 240 is fixed in the fixing drum 260 and the first assembly 300 is completed.

Referring to FIG. 5B, the upper bearing 220 is forcedly fit, from the upper part to the lower part, in the middle axial cavity 211 formed on the rotational drum 210, and the lower bearing 230 is forcedly fit, from the lower part to the upper part of the rotational drum 210. The upper and the lower bearings 220 and 230 are forcedly fit up to the bearing settling part 212, so that the second assembly 310 is completed.

Referring to FIG. 5C, the shaft 240 forcedly fit in the lower axial cavity 262 of the fixing drum 260 in the first assembly 300, is inserted, in a sliding manner, into the inner rings 222 and 232 of the upper and the lower bearings 220 and 230 of the second assembly 310, so that the third assembly 320 is completed. The inner diameters of the inner rings 222 and 232 of the upper and the lower bearings 220 and 230, are larger than the diameter of the shaft 240, so that the shaft 240 is inserted, in a loosely fitting manner, into the inner rings 222 and 232 of the upper and the lower bearings 220 and 230. If the insertion is completed, the projection 264 projected upward on the outer periphery of the lower axial cavity 262 of the fixing drum 260 is touched by the inner diameter of the lower bearing 230.

Referring to FIG. 5D, the elastic member 270 is inserted into the third assembly 320. The coil spring, elastic member 270 exemplified in the embodiment of the present invention, is inserted along the outer periphery of the shaft 240, so that the fourth assembly 330 is completed. It is preferable that since having a slightly larger diameter than the diameter of the shaft 240, the coil spring 270 is inserted by a little force from the upper part. With such a diameter, the coil spring 270 moves little on the outer periphery of the shaft 240 after being inserted onto the shaft 240.

Referring to FIG. 5E, an upper part of the shaft 240 of the fourth assembly 330 is forcedly fit in the upper axial cavity 252 formed on the drum cover 250. At this point, the elastic member 270 is compressed by being touched by one end of the drum cover 250. The elastic member 270 compressed in this manner, applies a load on the inner ring 222 of the upper bearing 220, and the projection 264 of the fixing drum 260 applies a load on the inner ring 232 of the lower bearing 230. With such a configuration, a pre-load is applied to the upper and the lower bearings 220 and 230 so that the rotational drum 210 is rotated in a stable manner.

As described above, according to the improved head drum assembly of the present invention and the magnetic recording/reproducing apparatus having the same, and the method for assembling the head drum assembly, the inner diameters of the upper and the lower bearings are made the same, so that the assembling process is simplified. Also, since the same bearing is used for the upper and the lower bearings, bearing manufacturing costs can be reduced.

Also, since the forcedly fitting process is reduced in the conventional assembling process for the head drum assembly, the productivity of the head drum assembly can be improved.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A head drum assembly of a magnetic recording/reproducing apparatus comprising:
a rotational drum rotatably disposed on a shaft;
an upper bearing and a lower bearing installed between the rotational drum and the shaft;
a fixing drum and a drum cover respectively fixed to the shaft, the upper and the lower bearings being installed on the shaft in a loosely fitting manner to apply a pre-load on the upper and the lower bearings; and
an elastic member for applying a load on an inner ring of either of the upper and the lower bearings.

2. The head drum assembly according to claim 1, wherein the upper and the lower bearings have the same diameter.

3. The head drum assembly according to claim 2, wherein a projection is formed on the fixing drum, for supporting the inner ring of the lower bearing, and the elastic member applies a load on the inner ring of the upper bearing.

4. The head drum assembly according to claim 3, wherein the elastic member is a coil spring.

5. A magnetic recording/reproducing apparatus comprising:
a deck on which a variety of parts for recording and reproducing data on and from the magnetic tape is installed; and
a head drum assembly which includes a rotational drum mounted on the deck and rotatably disposed on a shaft, for recording and reproducing information on and from the magnetic tape;
an upper bearing and a lower bearing installed between the rotational drum and the shaft;
a fixing drum and a drum cover fixed to the shaft, the upper and the lower bearings being installed on the shaft, in a loosely fitting manner to apply a pre-load on the upper and the lower bearings; and
an elastic member for applying a load on an inner ring of either of the upper and the lower bearings is provided.

6. The magnetic recording/reproducing apparatus according to claim 5, wherein the upper and the lower bearings have the same diameter.

7. The magnetic recording/reproducing apparatus according to claim 6, wherein a projection is formed on the fixing drum, for supporting the inner ring of the lower bearing, and the elastic member applies a load on the inner ring of the upper bearing.

8. A method for assembling a head drum assembly of a magnetic recording/reproducing apparatus rotatably disposed on a deck, for recording and reproducing data on and from a magnetic tape, the method comprising the steps of:
preparing a first assembly by forcedly fitting a shaft in a fixing drum;
preparing a second assembly by forcedly fitting a plurality of bearings in a rotational drum;
combining the first assembly and the second assembly by loosely fitting a plurality of bearings in the shaft; and
installing an elastic member on the shaft so that a load is applied on an inner ring of any one of a plurality of bearings.

9. The method according to claim 8, wherein the step of installing the elastic member comprises the steps of:
mounting the elastic member on the shaft so that one side of the inner ring of any one of a plurality of bearings contacts one side of the elastic member; and
forcedly fitting the drum cover in the shaft so that a load is applied on the other side of the elastic member.

10. The method according to claim 8, wherein a plurality of bearings comprises an upper bearing and a lower bearing, the fixing drum has a projection in its upper end, and the step of combining the first assembly and the second assembly comprises the steps of:
loosely fitting the shaft in the lower bearing;
loosely fitting the shaft in the upper bearing; and
closely fitting the second assembly in the shaft so that the inner ring of the lower bearing is supported by the projection.
